(19) United States
(12) Patent Application Publication
(10) Pub. No.: US 2019/0162331 A1
(43) Pub. Date: May 30, 2019

(54) HOSE AND CABLE PROTECTOR

(71) Applicant: WAGRED INNOVATIONS INC., Lloydminster (CA)

(72) Inventors: Cole Jordan Wagner, Saskatoon (CA); Christopher John Reddin, Courtenay (CA)

(21) Appl. No.: 16/203,264

(22) Filed: Nov. 28, 2018

Related U.S. Application Data
(60) Provisional application No. 62/591,453, filed on Nov. 28, 2017.

(51) Int. Cl. F16L 3/04; F16L 3/24

(52) U.S. Cl. CPC F16L 3/04; F16L 3/24

(57) ABSTRACT

A protector device for securing an elongate member, such as a hose or cable, to an anchor structure and protecting the member from kinking and/or twisting. The protector device has a generally semi-circular central portion with first and second arms extending toward a receiving end and converging toward a minimum point. The arms can diverge after reaching the minimum point to discourage twisting of the elongate member. The central portion and first and second arms define a central opening. Retaining mechanisms can be used to secure the elongate member to the protector. The central portion has a radius of curvature greater than a curvature at which the member will kink. The protector can be secured to the anchoring structure by manipulating the arms of the protector from a resting position to an open position, locating the anchoring structure in the central opening, and returning the arms to the resting position.

### CROSS-REFERENCE TO RELATED APPLICATIONS

This application claims the benefit of U.S. Provisional Patent application Ser. No. 62/591,453, filed Nov. 28, 2017, the entirety of which is incorporated herein by reference.

### FIELD

Embodiments disclosed herein generally relate to an apparatus for securing and protecting hoses, cables, and other elongate members. More specifically, an apparatus is provided for securing hoses and cables to an anchoring structure such as a handrail and protecting against kinking or twisting thereof.

### BACKGROUND

Hoses and cables are ubiquitous on construction worksites, oil rigs, workshops, and the like. Hoses are typically used as conduits to supply fluids such as air, water, oil, or fuel, for example to hydraulically or pneumatically actuated tools or welding equipment. Cables are often used to transmit electrical power and/or signals between equipment. Often, hosing and/or cabling are routed through worksites on an ad hoc basis, as the hosing and cabling are usually only required temporarily. It is important to secure hosing/cabling such that it does not shift excessively about the worksite, as such movement can create a hazard and potentially cause injury to personnel or damage property. Additionally, the tools and instruments which receive such hosing and cabling are frequently moved to different locations, which in turn often necessitates the relocation or rerouting of the hosing or cabling connected thereto. As a convenient and temporary means to route hosing and cabling and prevent hosing and cabling from shifting excessively during use, workers and operators often secure hosing and cabling to anchor structures such as handrails, poles, and the like.

As shown in FIGS. 1A and 1B, methods of securing hosing and cabling 8 to anchor structures 6 may comprise, for example, locating a first length of hosing/cabling 8a on one side of the anchor structure 6 and a second length 8b on the other side of the anchor structure 6, bending the hose/cable 8 over the anchor point 6, and tying the first and second lengths of hosing/cabling 8a, 8b together with string, rope, cable ties, or any other suitable devices available to the operator. Securing the normally unidirectional line of the hosing/cabling to the anchoring structure by tying the first and second lengths of hose/cable together is advantageous over merely securing the hosing/cabling to the anchor structure at a single point, as the first and second lengths of hosing/cabling are first directed downwards instead of being allowed to extend across the worksite at a potentially inconvenient or dangerous height. However, securing the hosing/cabling in such a manner introduces the risk of kinking the hose/cabling at the reversal point/bend point, as shown in FIG. 1A, or the first and second lengths of hosing twisting together, as shown in FIG. 1B, which may impede tool operation or present a safety risk. In some circumstances, kinking or twisting of the hose/cable irreparably compromises its function and the hose/cable must be replaced.

There is a need for a device for temporarily and conveniently securing hosing and cabling to an anchor structure while protecting said hosing/cabling from kinking, twisting, or otherwise being damaged.

### SUMMARY

Generally, a protector device is provided for securing a flexible, elongate member, such as a hose or cable, to an anchor structure and protecting the member from kinking and/or twisting. The protector device comprises a generally horseshoe, U, or Ω-shaped body comprising a generally semi-circular central portion with first and second arms extending from both ends of the central portion toward a receiving end of the protector and converging toward a minimum point. A central opening is defined between the central portion and first and second arms. In embodiments, the arms diverge after reaching the minimum point so as to discourage twisting of the elongate member secured thereto. One or more retaining mechanisms can cooperate with the protector to secure the elongate member thereto. At least the central portion has a radius or circle of curvature greater than the curvature at which the member will kink, such that when the member is secured to the protector, it is reinforced by the protector and protected against kinking. The protector can also be laterally curved to form a retaining trough to receive and more securely retain the elongate member. The first and second arms of the protector can be manipulated from a resting position to an open position, wherein the arms are spread apart, for receiving the anchor structure into the central opening. In embodiments, the body of the protector is made at least partly of a resilient material, such that the arms may be flexibly spread apart, while being rigid enough to maintain the elongate member at the desired curvature. The protector can be removably secured to the anchoring structure by manipulating the arms of the protector apart to the open position, locating the anchoring structure in the central opening, and returning the arms to the resting position.

In a broad aspect, a protector for retaining an elongate member to an anchoring structure can comprise a body comprising a central portion having a generally curved shape and first and second arms extending therefrom towards a receiving end of the protector and converging to a minimum point, the central portion and first and second arms defining a central opening; and at least one retaining mechanism adapted to secure the elongate member to the protector; wherein the generally curved shape has a first radius of curvature that is greater than a second radius of curvature at which the elongate member will kink; and wherein the first and second arms can be manipulated between a resting position and an open position.

In an embodiment, a gap between the first and second arms at the minimum point is smaller than a diameter of the central opening when the arms are in the resting position.

In an embodiment, the diameter of the central opening is about the equal to a diameter of the anchoring structure.

In an embodiment, the first and second arms diverge after converging to the minimum point as they extend toward the receiving end.

In an embodiment, at least one of the central portion and first and second arms is laterally curved to form a retaining trough.

In an embodiment, the protector is made at least partially of a resilient material such that the first and second arms can be flexibly pulled apart from each other, and the protector has sufficient rigidity to maintain the elongate member at substantially the first radius of curvature when the elongate member is retained thereon.

In an embodiment, the entire body is made of a resilient material.

In an embodiment, the body is made of resilient material at least between the central portion and the first and second arms.

In an embodiment, a frictional material is located on a retaining surface of the body facing away from the central opening.

In an embodiment, a frictional material is located on an anchoring surface of the body facing toward the central opening.

In an embodiment, the retaining mechanism is attached to the body.

In an embodiment, the retaining mechanism comprises at least the first and second arms being configured to retain the elongate member with an interference fit.

In an embodiment, the retaining mechanism is discrete from the body.

In an embodiment, the retaining mechanism is a cable tie.

In an embodiment, the retaining mechanism comprises one or more straps, each strap having a fastener adapted to secure the member to the body.

In an embodiment, the retaining mechanism comprises clamps configured to couple with the body to secure the member to the body.

In an embodiment, the retaining mechanism comprises a first portion of the body complementary to, and configured to couple with, a second portion of the body to form a generally tubular combined body.

In another broad aspect, a method of securing an elongate member to an anchoring structure using a protector can comprise orienting a receiving end of the protector towards the anchoring structure; positioning the protector such that the anchoring structure is located between the first and second arms of the protector; manipulating the first and second arms of the protector to an open position; locating the anchoring structure within a central opening of the protector; manipulating the first and second arms of the protector to a closed position; and retaining the elongate member to the protector.

In an embodiment, the step of manipulating the first and second arms of the protector to the open position comprises forcing the protector towards the anchoring structure such that the anchoring structure drives the first and second arms apart.

In an embodiment, the step of retaining the elongate member to the protector comprises aligning the member with the protector and securing the member to at least the first and second arms of protector.

### BRIEF DESCRIPTION OF THE DRAWINGS

FIG. 1A is a perspective depiction of a prior art method for securing hosing, cabling, or some other flexible member to an anchor structure resulting in kinking of the member at the bend or reversal point;

FIG. 1B is a perspective depiction of the prior art method of FIG. 1A wherein the flexible member is subjected to twisting;

FIG. 2 is a front elevation view of an embodiment of a protector device disclosed herein;

FIG. 3A is a side elevation view of the protector device of FIG. 2;

FIG. 3B is a cross-sectional side view along line A-A of the protector device of FIG. 2;

FIG. 4 is a front elevation view of another embodiment of a protector device;

FIG. 5 is a perspective view of the protector device of FIG. 2;

FIG. 6 is a perspective view of an arm of the protector device of FIG. 2 having a clamp instead of straps;

FIG. 7A is a front elevation view of another embodiment of the protector device having tabs as retaining mechanisms;

FIG. 7B is a side elevation view of the protector device of FIG. 7A;

FIG. 8A is a perspective view of an alternative embodiment of a protector device formed of two complementary portions;

FIG. 8B is a perspective view of a first portion of the protector device of FIG. 8A;

FIG. 8C is a perspective view of a second portion of the protector device of FIG. 8A;

FIG. 9A is a front view of a protector device whose receiving end is facing an anchor structure, which is shown in cross-section;

FIG. 9B is a front view of the protector device of FIG. 9A having a force applied thereto towards the anchor structure such that its arms are driven apart to receive the anchor structure into a central bore of the device;

FIG. 9C is a front view of the protector device of FIG. 9A secured about the anchoring structure and receiving a hose thereon with a retaining mechanism prepared to retain the hose to the device; and

FIG. 9D is a front view of the protector of FIG. 9A showing the hose having been secured on the protector device by the retaining mechanism.

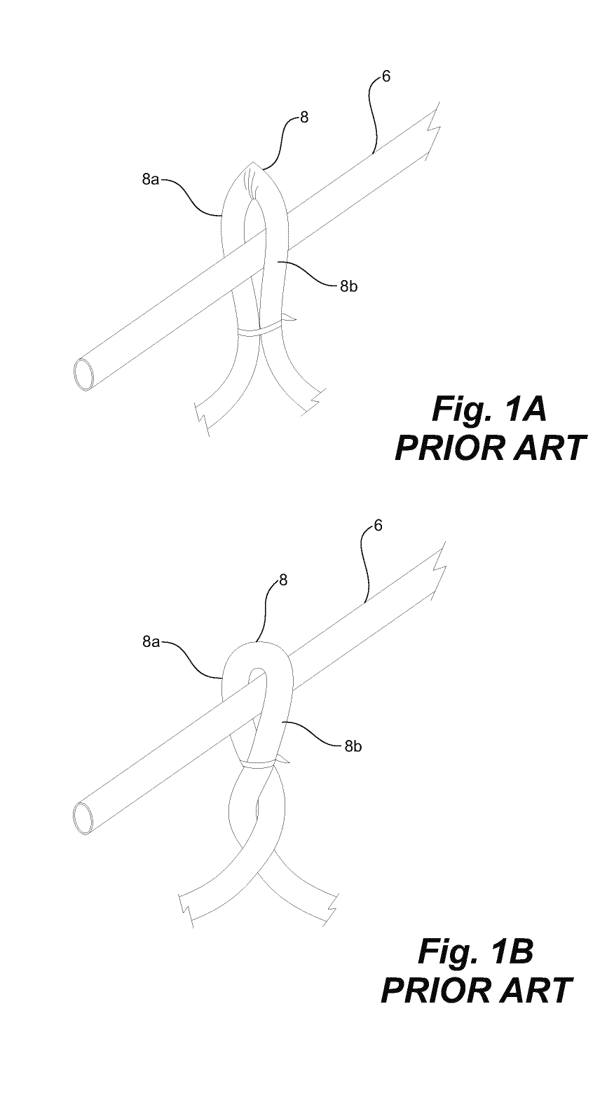

### DESCRIPTION

Generally, a protector device 10 is provided for removably securing a hose, cable, or other elongate member 8 to an anchoring structure 6 such as a handrail while protecting said elongate member 8 from kinking and mitigating twisting thereof.

The protector device 10 comprises a body having a central portion and two arms extending therefrom in generally the same direction to form a generally horseshoe, U, or Ω shape. The arms of the protector 10 can be spread apart from a resting position to an open position to allow an anchoring structure 6 to be passed therebetween and received into a central opening of the protector 10 defined by the central portion and arms. The arms can be returned to their original configuration to secure the protector 10 to the anchoring structure 6 until it is forcibly removed. The protector 10 is configured to retain an elongate member 8 thereon and protect said member 8 against kinking and/or twisting. Herein, reference to a hose includes hoses, cables, cords, and any other similar flexible, elongate members. Reference to a handrail includes any suitable anchoring structure such as handrails, poles, downspouts, and the like.

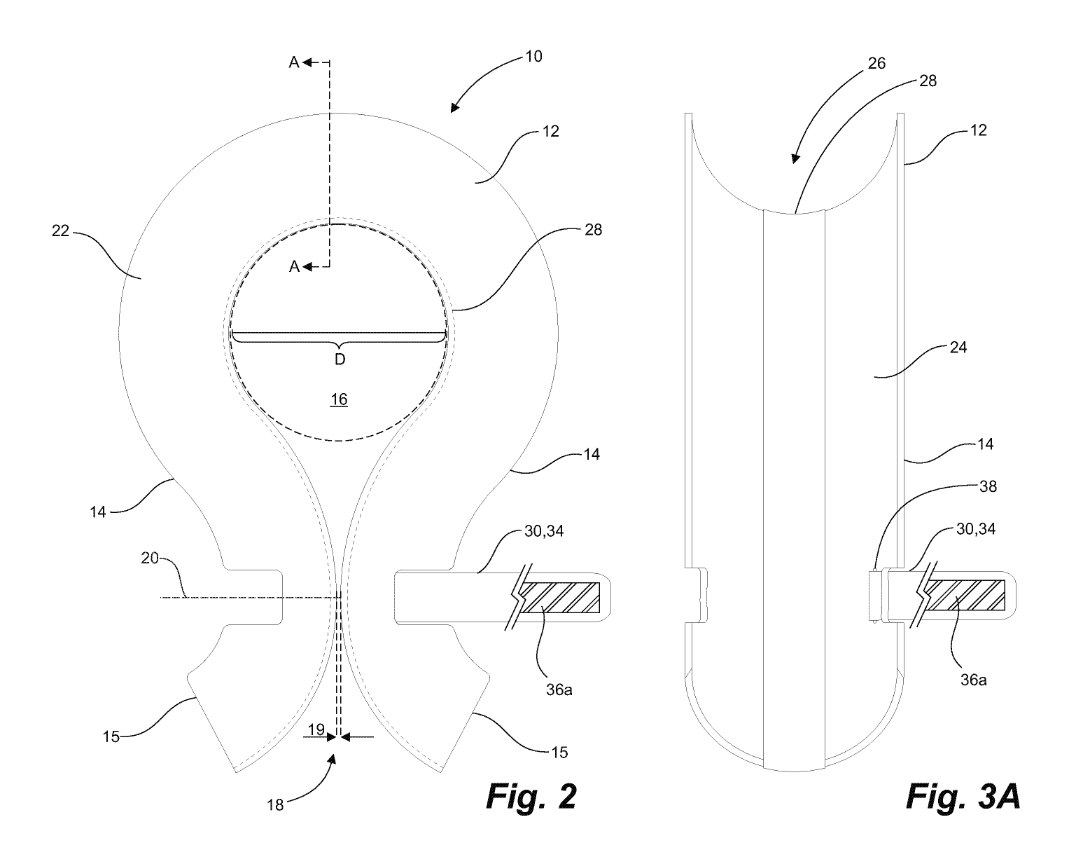

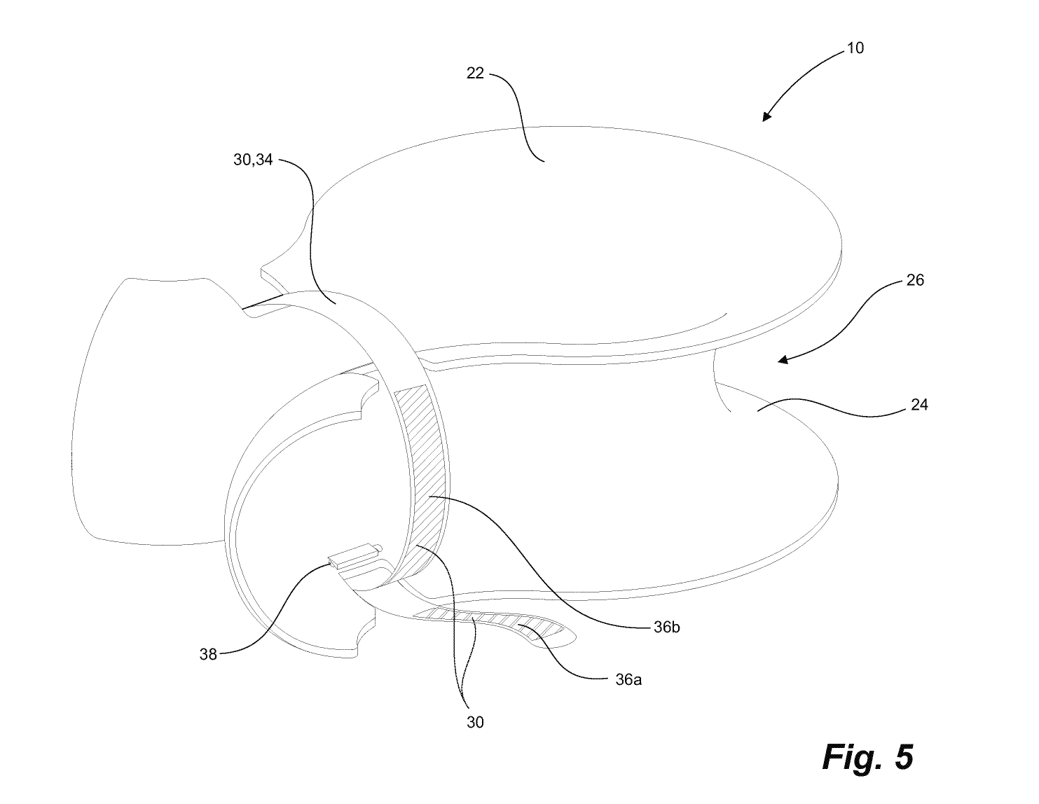

In greater detail, with reference to FIG. 2, the protector device 10 comprises a body having a generally semi-circular central portion 12 and first and second arms 14, 14 extending from each end of the central portion 12 in generally the same direction, forming a generally horseshoe, U, or Ω-shape. The central portion 12 and arms 14, 14 define a central opening 16 therebetween for receiving an anchoring structure 6, such as a tubular handrail, and removably securing the protector 10 thereto. The arms 14, 14 can converge as they approach a receiving end 18 of the protector 10 to better retain the protector 10 on the anchoring structure 6. The arms 14, 14 converge until they reach a minimum point 20, where the arms are closest together. In preferred embodiments, and as best shown in FIGS. 2, 4, 5, 7A, and 8A, the arms 14, 14 diverge after converging to the minimum point 20, forming flared portions 15 so as to direct first and second portions 8a, 8b of a hose 8 secured thereto away from one another to discourage twisting or knotting thereof. Such flared portions 15 also assist with securing the protector 10 to the handrail 6, as explained in further detail below. Preferably, the size of the gap 21 between the arms 14, 14 at the minimum point 20 is less than the diameter D of the central opening 16, such that the arms 14, 14 assist in retaining the protector 10 to the handrail 6. In embodiments, there can be substantially no gap 21 between the arms 14, 14 at the minimum point 20. In a preferred embodiment, the diameter D of the central opening 16 is about equal to or slightly less than the diameter of the handrail 6 to provide a more secure engagement between the handrail 6 and protector 10.

The longitudinal curvatures of the central portion 12 and arms 14, 14 of the protector 10 can have radii or circles of curvature that are greater than a radius or circle of curvature at which the hose 8 is at risk of kinking. As the hose 8 is at greater risk of kinking at a point adjacent the central portion 12, at least the central portion 12 should have a radius of curvature greater than the radius of curvature at which the hose 8 may kink. The elongate member 8 can be secured to the body of the protector 10 such that it is maintained at the curvature of the body, thereby reinforcing and protecting against kinking of the hose 8. The hose 8 is preferably secured to the protector 10 in such a manner so as to prevent creep of the hose 8 out of the protector 10. Such creep would result in an increased risk of the hose 8 kinking. In other embodiments, the central portion 12 and arms 14, 14 do not necessarily need to be curved, but could comprise a plurality of longitudinal sections angled from each other to form a generally horseshow, U, or Ω shape. One of skill in the art would understand that, so long as the angles between longitudinal sections of the protector 10 are such that the elongate member 8 will not kink when secured thereto, such a protector 10 would also serve to reinforce and protect against kinking of the member 8.

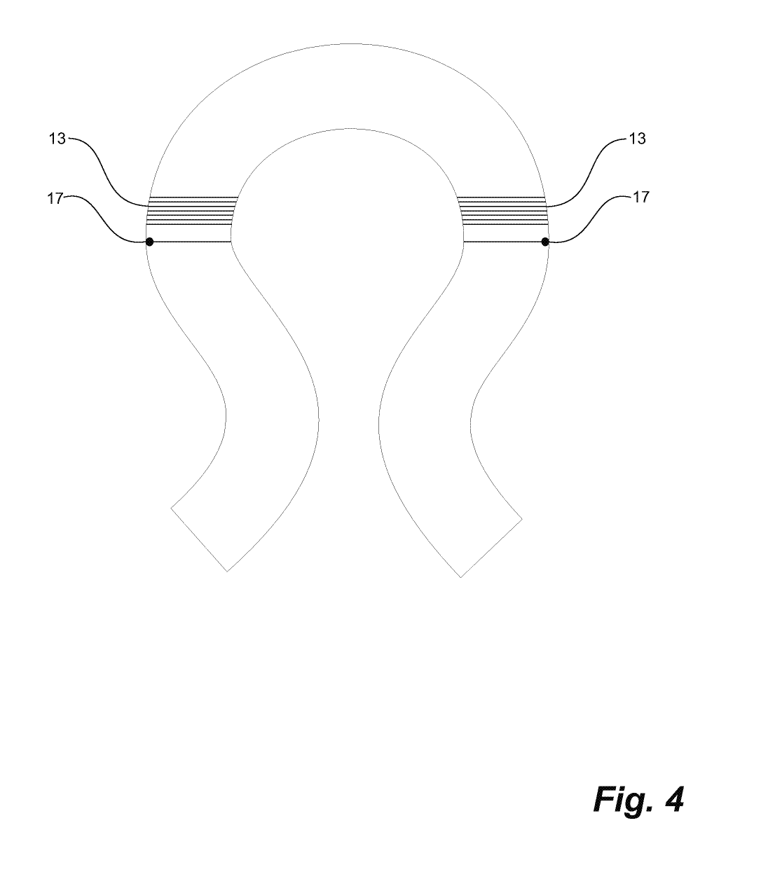

The body of the protector 10 can be made at least partially of a material having sufficient resilience to allow the arms 14, 14 to be manipulated from a resting position to an open position, wherein the arms 14, 14 are separated at least far enough to allow a handrail 6 or other anchoring structure to pass therebetween into the central opening 16, and return thereafter to substantially their resting position, while being rigid enough to maintain the hose 8 at substantially the curvature of the body of the protector 10 when the hose 8 is secured thereto. In embodiments, the entire body of the protector 10 is formed of a resilient, semi-rigid material, for example a plastic such as high-density polyethylene (HDPE) or low-density polyethylene (LDPE). In other embodiments, with reference to FIG. 4, the body of the protector 10 can be formed of a rigid material and have resilient zones 13 strategically positioned to allow first and second arms 14, 14 to open and allow the handrail 6 or other anchoring structure to pass therebetween. In other words, the arms 14, 14 are flexibly movable such that they can be spread apart to allow the handrail 6 to pass therebetween, yet are resilient enough to return substantially to their original positions and resist removal of the handrail 6 therefrom.

In further alternative embodiments, with reference to FIG. 4, the arms 14, 14 can be hingedly connected to the central portion 12 via hinges 17 such that the arms 14, 14 can be manipulated to the open position to receive the anchoring structure 6 into the central opening 16. The arms 14, 14 can be selectably locked in the resting position using means such as clips, pins, buckles, or other suitable fasteners such that they are not inadvertently moved to the open position when retained on an anchoring structure 6. In such embodiments, the body of the protector 10 does not need to have a resilience. FIG. 4 depicts a protector 10 having both resilient zones and hinges 17.

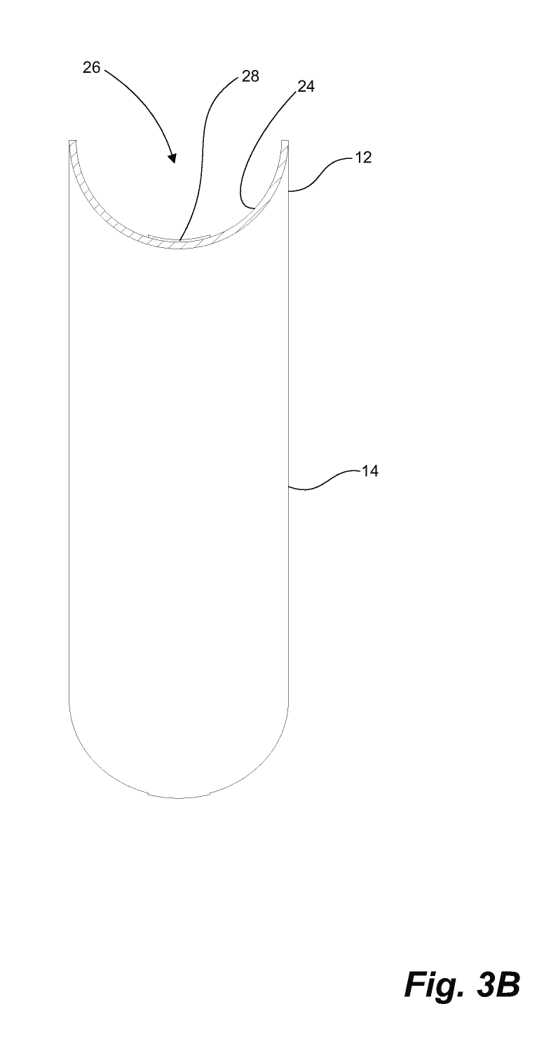

As best shown in FIGS. 2-5, the body of the protector 10 may further comprise an anchoring surface 22 facing the central opening 16 for engaging the handrail 6, and an opposite retaining surface 24 for receiving and securing a hose 8 thereon. As described above, the body of the protector 10 is longitudinally curved to form central opening 16. In embodiments, and as best depicted in FIG. 3B, the protector 10 can be also be laterally/cross-sectionally curved such that the retaining surface 24 is concave outwardly from the central bore 16, forming a hose-receiving trough 26. Such a cross-sectional curvature adds rigidity to the protector 10, enables it to more securely receive a hose 8, and limits lateral movement of the hose 8 when the hose is secured in the trough 26.

A frictional and/or semi-adhesive material 28 such as rubber can be located on one or both of the retaining and anchoring surfaces 24, 22. Providing frictional material 28 on the retaining surface 24 assists with securing a hose 8 to the protector 10 and preventing sliding of the hose 8 relative to the protector 10. Providing frictional material on the anchoring surface 22 permits better engagement between the protector 10 and the handrail 6 and mitigates sliding of the protector 10 thereon. For example, as shown in FIG. 3A, a strip of rubber 28 runs longitudinally on a portion of the retaining surface 24. Alternatively or in addition to providing a frictional/adhesive material 28, the retaining and/or anchoring surfaces 24, 22 can have a rough texture to provide a better engagement between the protector 10 and elongate member 8 and/or anchoring structure 6, respectively.

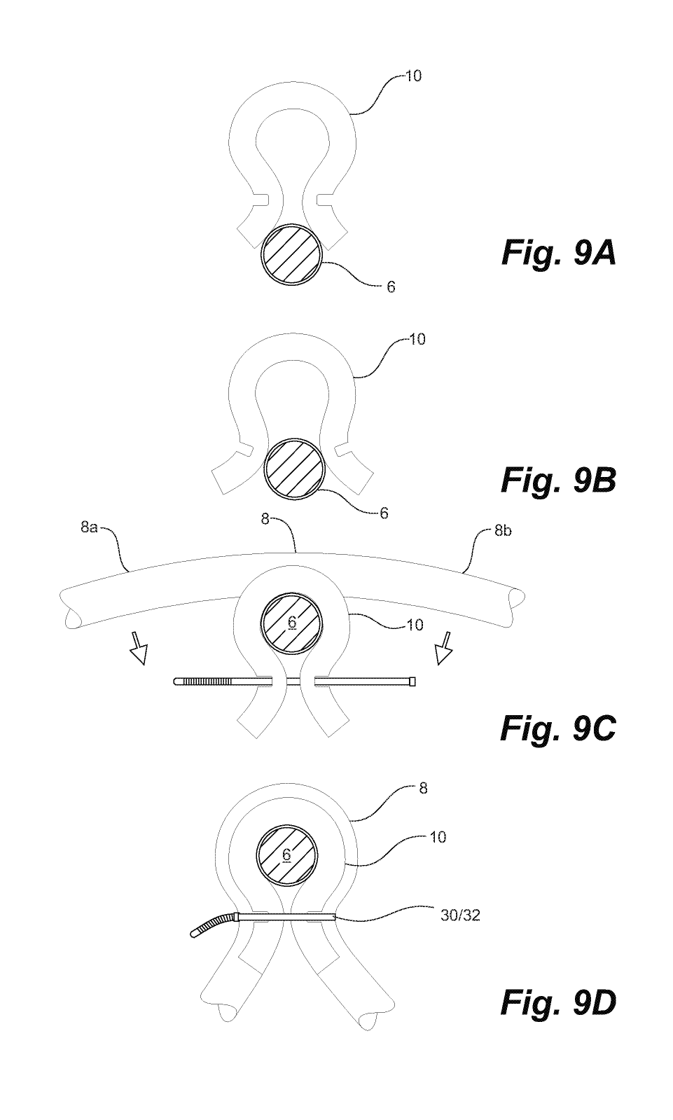

One or more retaining mechanisms 30 can be configured to cooperate with the protector 10 to secure a hose 8 thereto. With reference to FIGS. 9C and 9D, in an embodiment, the retaining mechanism 30 can be a discrete component separate from the protector 10, such as a cable tie 32, strap, or similar device, which is used to secure the hose 8 to the first and second arms 14, 14 and further secure the protector 10 to the handrail 6 by holding the arms 14, 14 together. In other embodiments, the retaining mechanism 30 can be attached or coupled to the body of the protector 10. The retaining mechanism 30 is configured to secure around both arms 14, 14 so as to retain a hose 8 to the protector 10. The retaining mechanism 30 also prevents the arms 14, 14 from being driven apart, thereby preventing the protector 10 from being inadvertently removed from the anchoring structure 6. For example, in the embodiment depicted in FIGS. 2, 3A, and 5, the retaining mechanism 30 is a strap 34 secured to an arm 14 of the protector 10, such as by being inserted through corresponding slot 38, and having a fastening means 36. In the depicted embodiment, the fastening means 36 is a hook and loop fastener, wherein the strap 34 has a hook section 36a having a plurality of hooks located at one area of the strap 34 and configured to removably engage with a loop section 36b having a plurality of loops and located on another area of the strap 34. The strap 34 can be wrapped around both arms 14, 14 and secured to itself using the fastening means 36. In other embodiments, the fastening means 36 can be clips, buckles, buttons, ratchets, or any other suitable fastening device known in the art, and can be stretchable or expandable, if desired.

In some embodiments, multiple retaining mechanisms 30 can be used to individually retain the hose 8 to each of the arms 14, 14, thereby allowing the protector 10 to be secured to, and removed from, a handrail 6 while still having the hose 8 secured thereto without having to disengage the retaining mechanisms 30. For example, one or more straps 34 could be secured to each arm 14 of the protector 10, each strap having a fastening means 36 to secure a hose 8 to the protector 10. Straps 34 can be located at the central portion 12 of the protector 10 to further secure the hose 8 to the protector 10.

If desired, as shown in FIGS. 2, 3A, 5, and 6, cutouts 48 can be formed in the body of the protector 10 at the longitudinal positions where the retaining mechanisms 30 are located to provide a better engagement between the retaining mechanisms 30 and the hose 8.

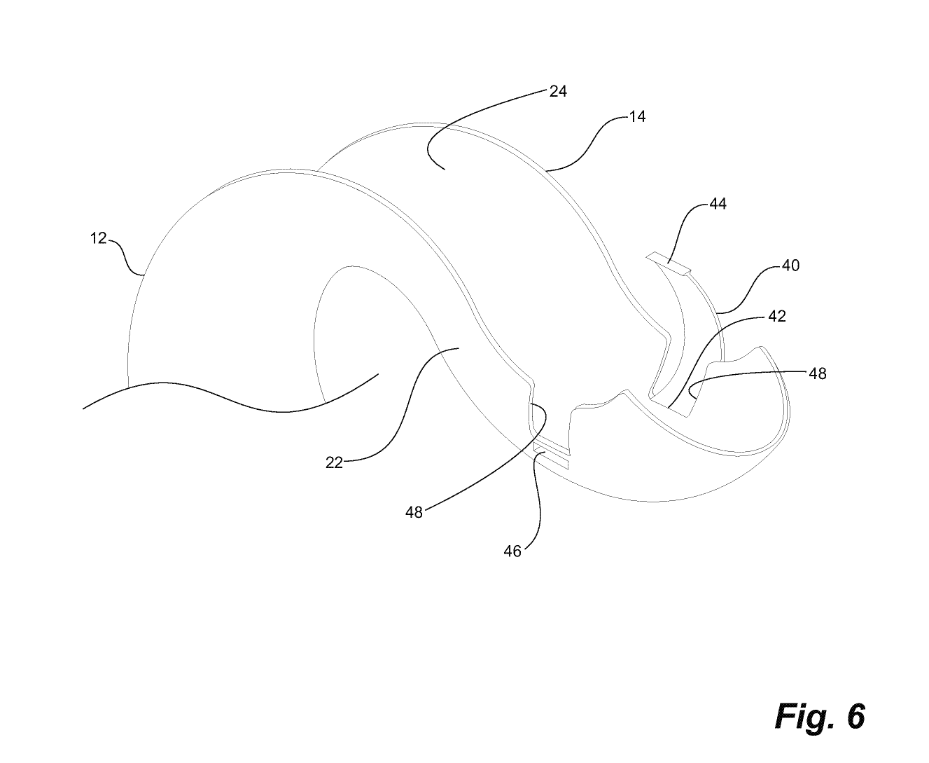

In alternative embodiments, as shown in FIG. 6, the retaining mechanism 30 can comprise clamps 40 which are selectably secured to the protector 10. The clamps 40 can be detachable from the protector 10, or can be fixed thereto. As shown, clamps 40 are hingedly fixed to the arms 14, 14 of the protector 10 at a hinge end 42, and each have a clip end 44 configured to engage with a corresponding opening 46 of the protector 10 to secure the hose 8 thereto.

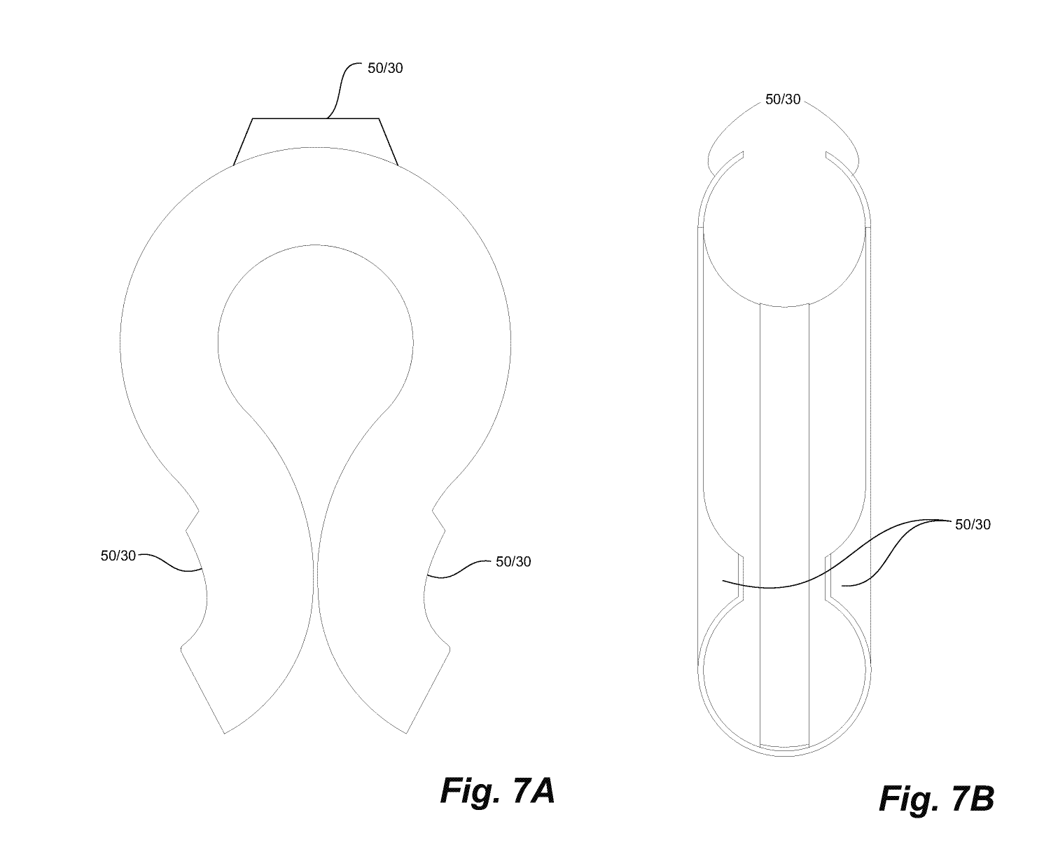

In further alternative embodiments, with reference to FIGS. 7A and 7B, the retaining trough 26 of the protector 10 can be shaped to retain hose 8 therein with an interference fit, thereby acting as the retaining mechanism 30. The protector 10 can also have pairs of laterally opposed retaining tabs 50 spaced longitudinally along the body of the protector 10 to act as retaining mechanisms 30. In use, the tabs 50 can be spread apart to allow a hose 8 to be inserted into the retaining trough 26. The resilience of the protector body then causes the tabs 50 to return to substantially their original configuration, thereby further securing the hose 8 in the retaining trough 26 of the protector 10.

As one of skill in the art would understand, it is possible to have more than two retaining mechanisms 30 to secure a hose 8 to the protector 10. For example, as shown in FIG. 7A, in addition to the two pairs of tabs 50 located on each of the arms 14, 14 and functioning as retaining mechanisms 30, one or more additional retaining mechanisms 30, such as another pair of tabs 50, can be located on the arms 14, 14 or central portion 12 to better resist unwanted lateral or longitudinal movement of the hose 8 when it is secured to the protector 10. Additionally, a combination of the above-described retaining mechanisms 30 can be used to secure the hose 8 to the protector 10.

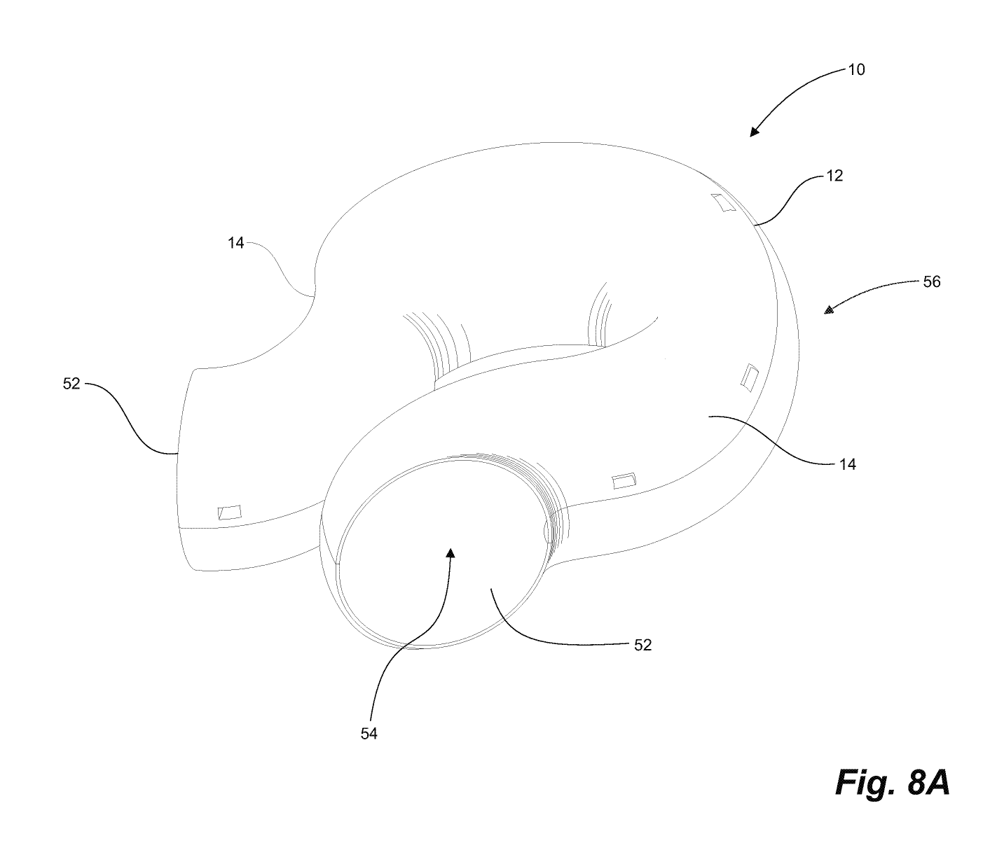

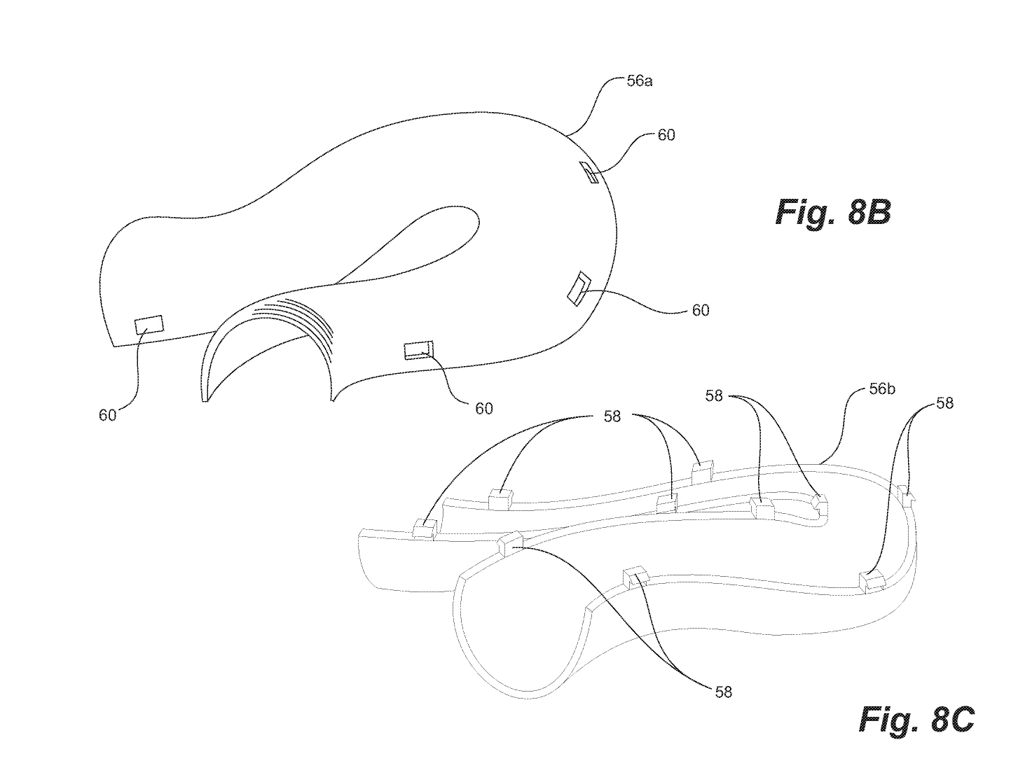

Turning to FIGS. 8A-8C, in alternative embodiments, the protector 10 can comprise a generally tubular body having a central portion 16 and first and second arms 14, 14 depending therefrom terminating at first and second open ends 52, 52. A hose 8 may be routed through a bore 54 of the tubular body. In such embodiments, the tubular body of the protector 10 serves as the retaining mechanism 30 for securing the hose 8 therein. In embodiments, the protector 10 can comprise two or more body portions to allow the hose 8 to be more conveniently retained in the protector 10. For example, as shown in FIG. 8, the body of the protector 10 can be longitudinally bisected to form two complementary portions 56a, 56b capable of being removably coupled with one another via a plurality of corresponding clips 58 and openings 60, or other suitable means, to form a combined body 56. A hose 8 can be received into a first of the two portions 56a, and the second portion 56b can be coupled to the first portion 52a by aligning the clips 58 and openings 60 and pressing the portions 52a, 52b together to secure the hose 8 in the bore 50.

Once the hose 8 is secured to the protector 10 by the one or more retaining mechanisms 30, it is maintained at the curvature of the body of the protector 10 until the retaining mechanisms 30 are disengaged. The maintenance of the hose 8 at the curvature of the protector 10 assists in preventing kinking of the hose. In embodiments with flared portions 15, the flared portions 15 direct the first and second lengths of the hose 8a, 8b away from each other to discourage twisting thereof.

In use, to secure a hose 8 to a handrail 6 using the protector 10, and referring to FIGS. 9A-9D, the protector 10 can be positioned such that the handrail 6 is located at the receiving end 18 of the protector 10 between the first and second arms 14, 14. The protector 10 can then be moved towards the handrail 6 such that the handrail 6 forces the arms 14, 14 apart to the open position and passes through the gap formed therebetween and into the central opening 16. As the handrail 6 passes between the arms 14, 14, the resilience of the protector body biases the arms 14, 14 back towards one another to the resting position such that they substantially reassume their original configuration and the gap returns to its original width. The handrail 6 is thereby retained in the central opening 16 and the protector 10 is secured to the handrail 6. In embodiments without flared portions 15, the arms 14, 14 can be manually spread apart to allow the handrail 6 to pass therebetween into the central opening 16. As shown in FIGS. 7C and 7D, a hose 8 can then be aligned with the protector 10, brought in contact with substantially the entire length of the retaining surface 24 of the protector 10, and retained thereto using the retaining mechanism 30, thereby securing the hose 8 to the handrail 6. Of course, one can first retain the hose 8 on the protector 10 before securing the protector 10 onto the handrail 6.

Although a few embodiments have been shown and described, it will be appreciated by those skilled in the art that various changes and modifications can be made to these embodiments, and embodiments can be combined, without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims.

We claim:

1. A protector for retaining an elongate member to an anchoring structure, comprising:
a body comprising a central portion having a generally curved shape and first and second arms extending therefrom towards a receiving end of the protector and converging to a minimum point, the central portion and first and second arms defining a central opening; and
at least one retaining mechanism adapted to secure the elongate member to the protector;
wherein the generally curved shape has a first radius of curvature that is greater than a second radius of curvature at which the elongate member will kink; and
wherein the first and second arms can be manipulated between a resting position and an open position.

2. The protector of claim 1, wherein a gap between the first and second arms at the minimum point is smaller than a diameter of the central opening when the arms are in the resting position.

3. The protector of claim 2, wherein the diameter of the central opening is about the equal to a diameter of the anchoring structure.

4. The protector of claim 1, wherein the first and second arms diverge after converging to the minimum point as they extend toward the receiving end.

5. The protector of claim 1, wherein at least one of the central portion and first and second arms is laterally curved to form a retaining trough.

6. The protector of claim 1, wherein the protector is made at least partially of a resilient material such that the first and second arms can be flexibly pulled apart from each other, and the protector has sufficient rigidity to maintain the elongate member at substantially the first radius of curvature when the elongate member is retained thereon.

7. The protector of claim 6, wherein the entire body is made of a resilient material.

8. The protector of claim 6, wherein the body is made of resilient material at least between the central portion and the first and second arms.

9. The protector of claim 1, wherein a frictional material is located on a retaining surface of the body facing away from the central opening.

10. The protector of claim 1, wherein a frictional material is located on an anchoring surface of the body facing toward the central opening.

11. The protector of claim 1, wherein the retaining mechanism is attached to the body.

12. The protector of claim 1, wherein the retaining mechanism comprises at least the first and second arms being configured to retain the elongate member with an interference fit.

13. The protector of claim 1, wherein the retaining mechanism is discrete from the body.

14. The protector of claim 13, wherein the retaining mechanism is a cable tie.

15. The protector of claim 1, wherein the retaining mechanism comprises one or more straps, each strap having a fastener adapted to secure the member to the body.

16. The protector of claim 1, wherein the retaining mechanism comprises clamps configured to couple with the body to secure the member to the body.

17. The protector of claim 1, wherein the retaining mechanism comprises a first portion of the body complementary to, and configured to couple with, a second portion of the body to form a generally tubular combined body.

18. A method of securing an elongate member to an anchoring structure using a protector, comprising:
orienting a receiving end of the protector towards the anchoring structure;
positioning the protector such that the anchoring structure is located between the first and second arms of the protector;
manipulating the first and second arms of the protector to an open position;
locating the anchoring structure within a central opening of the protector;
manipulating the first and second arms of the protector to a closed position; and
retaining the elongate member to the protector.

19. The method of claim 18, wherein the step of manipulating the first and second arms of the protector to the open position comprises forcing the protector towards the anchoring structure such that the anchoring structure drives the first and second arms apart.

20. The method of claim 18, wherein the step of retaining the elongate member to the protector comprises aligning the member with the protector and securing the member to at least the first and second arms of protector.
